(19) United States
(12) Patent Application Publication
(10) Pub. No.: US 2014/0101944 A1
(43) Pub. Date: Apr. 17, 2014

(54) Seam Ripper Scissors

(71) Applicant: Hyarlien Moultrie, Mt. Vernon, NY (US)

(72) Inventor: Hyarlien Moultrie, Mt. Vernon, NY (US)

(21) Appl. No.: 13/651,172

(22) Filed: Oct. 12, 2012

(51) Int. Cl. B26B 13/06; D05B 89/00

(52) U.S. Cl. 30/254

(57) ABSTRACT

The apparatus of the present invention is a hand operated seam ripping or cutting instrument. It comprises a pair of metal blades pivoted so that the sharpened edges slide toward or away from each other when the handles opposite to the pivot are brought close to or separate from each other. The unique ripping section, which has an appearance of a craved hook, residing at the free end of one of the blades, is provided with a concave surface which is preferably sharp enough to rip a sewed seam but dull enough to prevent from inadvertently cutting the fabric and a tip that is preferably somewhat thin but rounded or smooth to avoid accidental snags in fabric or poke on the user's

### BACKGROUND OF THE INVENTION

1. Field of the Invention

The present invention relates to an apparatus for cutting or ripping sewn seams and more particularly to a seam ripper in combination with a pair of regular scissors.

2. Description of Related Art

There are many reasons to remove stitching/seams from a garment. One of the common reasons is that they are not straight. Other common reasons include garment alterations, etc. It is not advisable to use razor blades or sharp knives to removes stitches. This type of tool will not only cut the thread but also will cut through the fabric easily. There are tools designed to remove stitches/seams. Nevertheless, the seam rippers that are on the market today are hard to handle when a user is trying to remove sewing machine stitches; they can put a rip or a hole in the fabric, damaging the item. Therefore, it is desirable to have a seam ripper that can rip or cut through stitches or threads or seams with precision and ease and able to remove sewing machine stitches.

Scissors of various types are known in the art and are commonly used household tools that can be used for a variety of purposes including cutting fabrics during garment alteration. Scissors are easy to use and normally can provide precise cutting.

Therefore it is desirable to have a tool that combines a seam ripper with scissors so that the tool can be used as a seam ripper that can rip or cut through sewing machine stitches with precision and ease as well as a pair of regular scissors.

### SUMMARY OF THE INVENTION

In an exemplary embodiment of the present invention, there is disclosed a seam ripper scissors according to the present invention.

The apparatus of the present invention is a hand operated seam ripping or cutting instrument. It comprises a pair of metal blades pivoted so that the sharpened edges slide toward or away from each other when the handles opposite to the pivot are brought close to or separate from each other.

The handles could have differing constructions, they are preferably identical. Each of the handle units may include a molded plastic section. Material for manufacturing can be metal or stainless steel or any other similar hard and sharp material.

The unique ripping section, which has an appearance of a craved hook, residing at the free end of one of the blades, is provided with a concave surface which is preferably sharp enough to rip a sewed seam but dull enough to prevent from inadvertently cutting the fabric and a tip that is preferably somewhat thin but rounded or smooth to avoid accidental poke on the user's skin or fabric. The ripping section may have different shaped surface

This crave hook ripping section allows a user to easily go under the stitches and easily clip them using both blades as the user move forward hooking the thread (seam) and clipping (ripping). The seam rippers that are on the market today are hard to handle when a user is trying to remove sewing machine stitches, damaging the item. The seam ripper scissors of the present invention is a great tool for doing alterations on garments. It helps a user to remove the unwanted stitches faster on anything that has sewing machine stitches. Moreover, the handles of the seam ripper scissors give user leverage and easy manipulation like a pair of regular scissors provides. The seam ripper scissors can also be used for other household that require a regular scissors such as cutting fabric if desired or opening up food boxes in the kitchen. In addition it can be used to open grocery products as well as a wide variety of other items that may need minor cutting. This includes paper product goods as well as plastic seal coverings found on many wrapped items one purchases from time to time.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is a front view of a seam ripper scissors according to one embodiment of the present invention that is designed for a right-handed user.

FIG. 2 is an exploded view of the seam ripper scissors in FIG. 1.

FIG. 3 is an enlarged view of the ripping section, which has a craved hook shape, at the tip of one blade of the seam ripper scissors according to the present invention.

FIG. 4 is a front view of a seam ripper scissors according to another embodiment of the present invention that is designed for a right-handed user.

FIG. 5 is an exploded view of the seam ripper scissors in FIG. 4.

FIG. 6 is a front view of a seam ripper scissors according to an embodiment designed for a left-handed user.

FIG. 7 is an enlarged view of the ripping section, which has a V-shaped surface, at the tip of one blade of the seam ripper scissors according to the present invention.

### DESCRIPTION OF THE PREFERRED EMBODIMENT

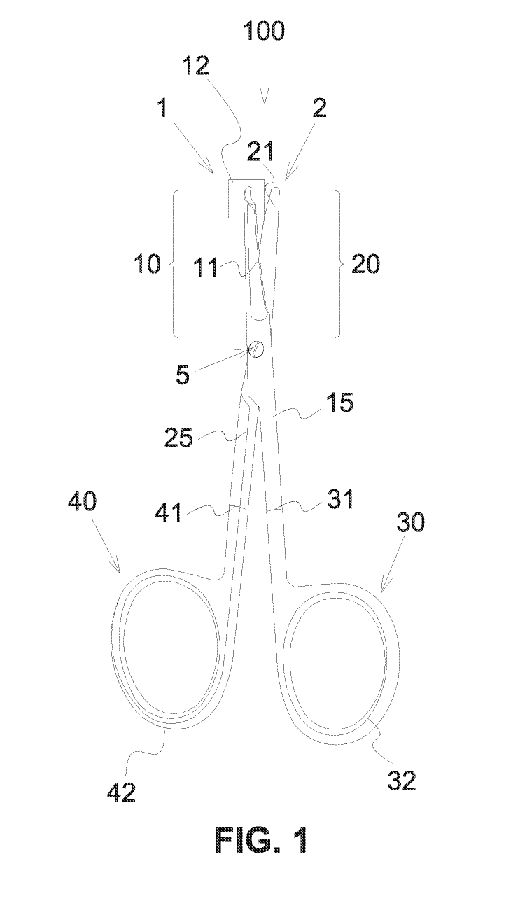

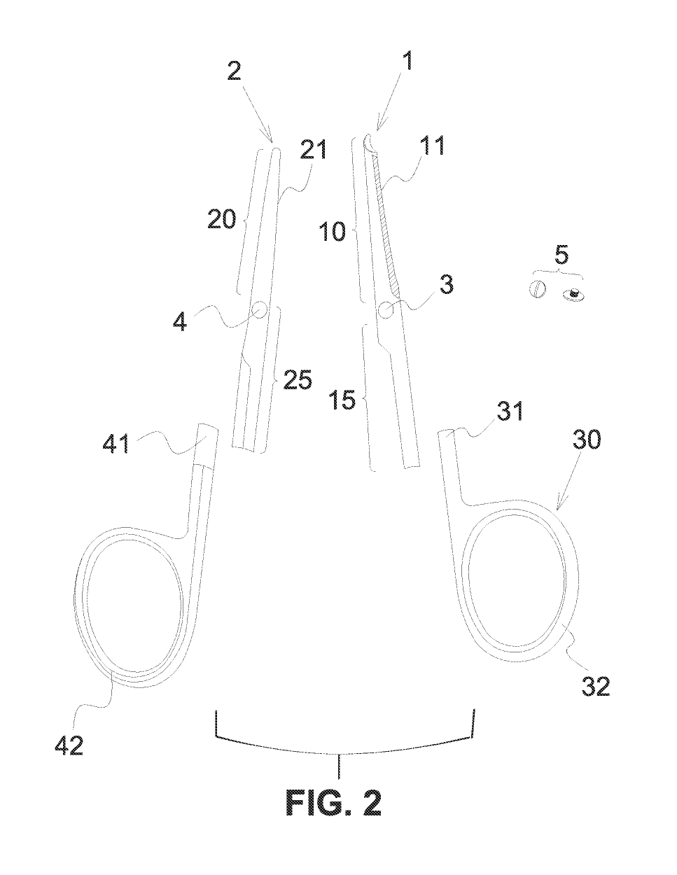

Referring to FIGS. 1 and 2, there is disclosed a pair of seam ripper scissors 100 according to an embodiment of the present invention. FIG. 1 is a front view of the seam ripper scissors 100 which is for a right-handed user and FIG. 2 is an exploded view showing all parts of the seam ripper scissors 100 disclosed in FIG. 1. The pair of seam ripper scissors 100 comprises two metal pieces 1, 2 which have apertures 3, 4 of predetermined configuration at predetermined locations for receiving the means for pivot 5 whereby the two metal pieces 1, 2 can be connected and move relative to each other. Each of the metal pieces 1, 2 has at one end thereof blade 10, 20 with sharpened edge 11, 21 respectively and shaft 15, 25 at the opposite end thereof respectively. The seam ripper scissors 100 further comprises two plastic handles 30, 40, each of which has one end 31, 41 for attaching to the shaft 15, 25 and a bow 32, 42 for receiving user's thumb and fingers at the other end. Although the handles 30, 40 could have different constructions, they are preferably identical. The handles 30, 40 may have different colors. The length of the shaft 15, 25 and the depth that the shaft 15, 25 extends into the handle 30, 40 may vary. Preferably, the construction should offer sufficient leverage for ripping and cutting purpose and economic in respect of manufacturing cost. The shaft 15, 25 may be molded into the handle 30, 40 and/or by any methods known in the art. The scissors with plastic handles normally are less expensive scissors than a pair of scissors completely made from metal piece.

The means of pivot 5 passes through aligned apertures 3, 4 in each of the metal pieces 1, 2 so that the metal pieces are attached in a manner such that the sharpened edges 11, 21 of the blades 10, 20 slide against each other when the handles 30, 40 are brought close to each other and the sharpened edges 11, 21 slide away from each other when the handles 30, 40 are separated away from each other.

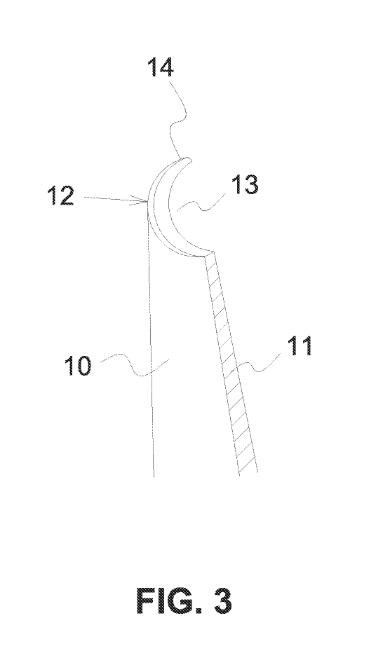

A unique feature of this seam ripper scissors 100 of the present invention resides in the ripping section 12 located on the free end of one of the blades 10 as shown in FIGS. 1-2. The enlarged view of this ripping section 12 is illustrated in FIG. 3 where the ripping section 12 having an appearance of a craved hook is provided with a concave surface 13 which is not razor sharp and a tip 14 that is thin but rounded and smooth. The ripping section's concave surface 13 is preferably sharp enough to rip or cut a sewn seam (or thread) but dull enough to prevent from inadvertently cutting the fabric; it is primarily the shearing action between the concave surface 13 of the ripping section 12 and the sharpened edge of blade 20 that rips or cuts the seam (thread) when the craved hook ripping section 12 is under the seam and the seam ripper scissors 100 is moved forward by the user. The tip 14 is preferably thin so it is easy to go under the seam but slightly rounded or smooth to reduce accidental snags in the fabric or poking in user's hand.

The sharpened edges 11, 21 of the seam ripper scissors 100 when slide against each other are sharp enough to work as a pair of regular scissors to cut the fabric as desired or open kitchen boxes paper product goods, and plastic seal coverings.

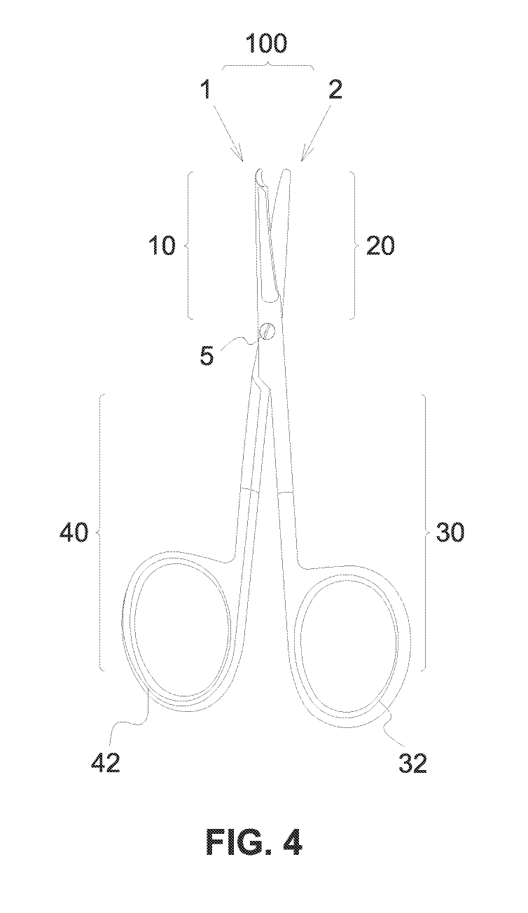

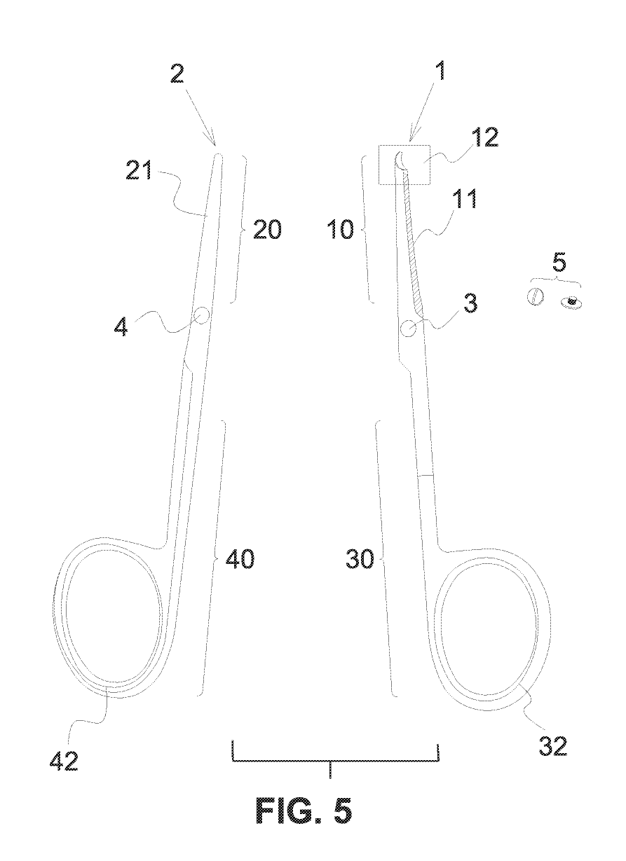

Referring to FIGS. 4 and 5, there is disclosed the seam ripper scissors 100 according to another embodiment of the present invention. FIG. 4 is a front view of the seam ripper scissors 100 which is for a right-handed user and FIG. 5 is an exploded view showing all parts of the seam ripper scissors 100 disclosed in FIG. 1. The seam ripper scissors 100 comprises two metal pieces 1, 2, each of which has at one end thereof blade 10, 20 with sharpened edge 11 and 21 respectively and handle 30, 40 with bow 32, 42 at the opposite end thereof respectively. Each of the metal pieces 1, 2 has an aperture 3, 4 of predetermined configuration at predetermined locations in between the two ends for receiving the means for pivot 5 whereby the two metal pieces 1, 2 can be connected and move relative to each other as discussed in the foregoing paragraphs. The blade 10 has a unique ripping section 12 as discussed in the foregoing paragraphs. Traditionally, scissors made entirely of metal are provided by machining or molding metal parts and such scissors are generally expensive.

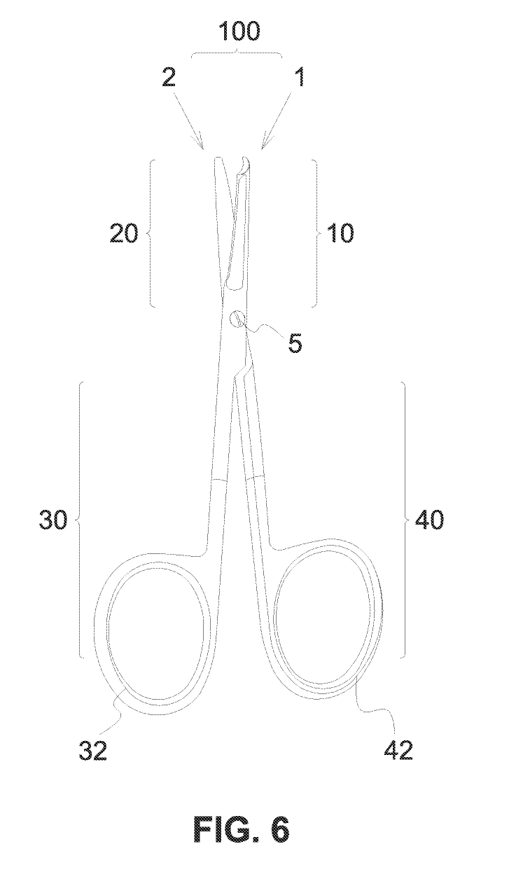

Referring to FIG. 6, there is disclosed a seam ripper scissors 100 according to an embodiment that is for a left-handed user. The features and parts of this embodiment are same as those of the embodiment for a right-handed user. The seam ripper scissors 100 according to the present invention may also be manufactured as ambidextrous.

The means for pivot 5 may include a rivet or other suitable means which can pivotally connect two metal pieces and provide them relative movement along a cutting plane for shearing contact with a surgical suture to be cut.

Movement of the ripping section 12 on the blade 10 and sharp edge 21 on the other blade 20 slide toward and away from each other is controlled by fingers holding the bows 32, 42 of the handles 30, 40. Sometimes, the seams may be ripped apart from the fabric by holding the handles still with the tips of both blades 11, 21 open and move the seam ripper scissors 100 forward without performing relative movement.

This crave hook ripping section 12 allows a user to easily go under the stitches and easily clip them using both blades as the user move forward hooking the thread (seam) and clipping (ripping). The advantage of this seam ripper scissors 100 over other seam ripper that is available in the marketplace is when running into tight stitches, the seam ripper scissors 100 can work its way into the tight stitches and easily clip away stitches, without ruining the fabric or outfit. As the user clips with the craved hook ripping section 12 along the seams/stitches, this apparatus 100 allows the user to clip both sides, or inside the center of the stitches. The user can just clip and pull the fabric gently while the fabric laying flat on a table or on their lap, whereby the seams will come apart. The seam rippers that are on the market today are hard to handle when a user is trying to remove sewing machine stitches, they can put a rip or a hole in the fabric, damaging the item. The seam ripper scissors 100 of the present invention is a great tool for doing alterations on garments. It helps a user to remove the unwanted stitches faster on anything that has sewing machine stitches. Even those hard to reach thread areas, it doesn't matter what kind of stitches are on the fabric, (zigzag, broidery etc.), the seam ripper scissors 100 of the present invention can rip it apart. Moreover, the handles of the seam ripper scissors 100 give user leverage and easy manipulation like a pair of regular scissors provides. The seam ripper scissors 100 can also be used for other household that require a pair of regular scissors such as cutting fabric or opening up food boxes in the kitchen, or paper product goods, or plastic seal coverings on various items.

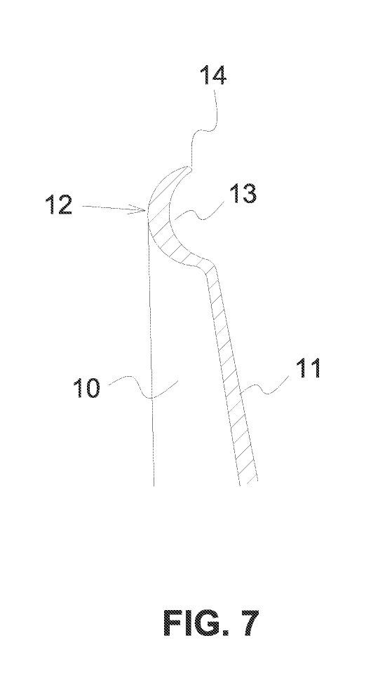

The ripping surface 13 in the ripping section 12 may have a different shape other than a craved hook, such as a V-shape as shown in FIG. 7.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. A seam ripper scissors for ripping or cutting seams comprising:
means for pivot;
two metal pieces which have apertures of predetermined configuration at predetermined locations for receiving the means for pivot whereby the two metal pieces can be connected and move relative to each other, each of the metal pieces has a blade with sharpened edge at one end thereof, and a shaft at the opposite end thereof, one of the blade has a ripping section which is shaped like a craved hook and provided with a concave surface that is not razor sharp and a tip that is thin but rounded and smooth;
two plastic handles, each of which has one end for attaching to the shaft and a bow for receiving user's thumb and fingers at the other end, the shaft;
wherein the two shafts may be molded into the handles and the two metal pieces are connected by the means of pivot through the aligned apertures in the metal pieces in a manner such that the sharpened edges of the blades slide against each other when the handles are brought close to each other and the sharpened edges slide away from each other when the handles are separated away from each other.

2. The seam ripper scissors of claim 1 wherein the ripping section's concave surface is preferably sharp enough to rip or cut a sewn seam (or thread) but dull enough to prevent from inadvertently cutting the fabric and the tip is preferably thin so it is easy to go under the seam and slightly rounded or smooth to reduce accidental snags in fabric or poking in user's hand.

3. The seam ripper scissors of claim 2 wherein the sharpened edges of the blades when slide against each other are sharp enough to work as a pair of regular scissors to cut the fabric as desired or open kitchen boxes, or paper product goods, or plastic seal coverings.

4. The seam ripper scissors of claim 1 wherein the handles may have various colors and configurations.

5. A seam ripper scissors for ripping or cutting seams comprising:
means for pivot;
two metal pieces which have apertures of predetermined configuration at predetermined locations for receiving the means for pivot whereby the two metal pieces can be connected and move relative to each other, each of the metal pieces has a blade with sharpened edge at one end thereof, and a handle at the opposite end thereof, one of the blade has a ripping section which is shaped like a craved hook and provided with a concave surface that is not razor sharp and a tip that is thin but rounded and smooth;
wherein the two metal pieces are connected by the means of pivot through the aligned apertures in the metal pieces in a manner such that the sharpened edges of the blades slide against each other when the handles are brought close to each other and the sharpened edges slide away from each other when the handles are separated away from each other.

6. The seam ripper scissors of claim 5 wherein the ripping section's concave surface is preferably sharp enough to rip or cut a sewn seam (or thread) but dull enough to prevent from inadvertently cutting the fabric and the tip is preferably thin so it is easy to go under the seam and slightly rounded or smooth to reduce accidental snags in fabric or poking on user's hand.

7. The seam ripper scissors of claim 6 wherein the sharpened edges of the blades when slide against each other are sharp enough to work as a pair of regular scissors to cut the fabric as desired or open kitchen boxes, paper product goods, or plastic seal coverings.

8. A seam ripper scissors for ripping or cutting seams comprising:
means for pivot;
two metal pieces which have apertures of predetermined configuration at predetermined locations for receiving the means for pivot whereby the two metal pieces can be connected and move relative to each other, each of the metal pieces has a blade with sharpened edge at one end thereof, and a shaft at the opposite end thereof, one of the blade has a ripping section which is provided with a ripping or cutting surface that is not razor sharp and a tip that is thin but rounded and smooth;
two plastic handles, each of which has one end for attaching to the shaft and a bow for receiving user's thumb and fingers at the other end, the shaft;
wherein the two shafts may be molded into the handles and the two metal pieces are connected by the means of pivot through the aligned apertures in the metal pieces in a manner such that the sharpened edges of the blades slide against each other when the handles are brought close to each other and the sharpened edges slide away from each other when the handles are separated away from each other.

9. The seam ripper scissors of claim 8 wherein the ripping section's ripping or cutting surface is preferably sharp enough to rip or cut a sewn seam (or thread) but dull enough to prevent from inadvertently cutting the fabric and the tip is preferably thin so it is easy to go under the seam but rounded or smooth to prevent it from accidentally poking the user's skin or fabric.

10. The seam ripper scissors of claim 9 wherein the ripping section's ripping or cutting surface is a V-shape.

11. The seam ripper scissors of claim 9 wherein the sharpened edges of the blades when slide against each other are sharp enough to work as a pair of regular scissors to cut the fabric as desired or open kitchen boxes, or paper product goods, or plastic seal coverings.

12. The seam ripper scissors of claim 8 wherein the handles may have various colors and configurations.
